(19) United States
(12) Patent Application Publication
(10) Pub. No.: US 2009/0303150 A1
(43) Pub. Date: Dec. 10, 2009

(54) Manufacturing method and structure of satellite disc antenna that integrally displays trademark by visual contrast of hollow hole

(76) Inventor: Wen-Chao Shen, Pa Teh City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,190

(22) Filed: Aug. 5, 2008

(30) Foreign Application Priority Data
Jun. 6, 2008 (TW) 097121039

(51) Int. Cl. H01Q 19/10; H01P 11/00

(52) U.S. Cl. 343/834; 29/600

(57) ABSTRACT

The present invention discloses a satellite disc antenna and its structure for displaying an integrally formed trademark through hollow holes by a visual contrast effect. The antenna is formed by punching holes on a metal plate to constitute a holed plate with densely distributed hollow holes, while maintaining the disc surface of a desired trademark pattern free of holes, so that the integrally formed trademark pattern can be shown clearly on the disc surface by the visual contrast effect. The satellite disc antenna can be manufactured synchronously without requiring any printing or coating. The invention can reduce the influence of climate changes and prevent the trademark pattern from being peeled off easily. Further, the hollow holes can be used for reducing the wind resistance, enhancing the durability of the antenna and maintaining the reliability of receiving signals.

### BACKGROUND OF THE INVENTION

1. Field of the Invention

The present invention relates to a method of manufacturing a satellite disc antenna and its structure, and more particularly to a method of forming a disc body with a plurality of densely distributed hollow holes on a metal plate, and displaying a predetermined trademark pattern through the densely distributed hollow holes by a visual contrast effect, such that a text or a figure of the trademark is formed directly on a disc surface.

2. Description of the Related Art

In the past, wireless communications on ground are usually affected by factors such as landforms and constructions, atmospheric layer, curvature of the earth, and electromagnetic field of the space, so that normal radio waves of communications are reflected, refracted and diffracted to give rise to poor communication effect and quality.

Thereafter, a communication satellite is introduced to overcome the shortcomings of traditional wireless communications, and an earth station including a dish antenna, a feedhorn, a low noise amplifier (LNA), a down converter, and a satellite is a major electronic means for receiving satellite signals, and thus radio wave signals transmitted by a satellite in a space orbit can be received effectively.

A dish antenna is a window for the whole earth station and its appearance looks like a dish, but its structure is actually in a parabolic shape for facilitating the focus of weak signals dispersed on the surface of the antenna, so that the front side of the antenna becomes a single focal point. Such focal point is usually used as a position for installing a feedhorn.

With reference to FIGS. 1A and 1B for a perspective view and a front view of a conventional disc antenna 10 respectively, an antenna with an external diameter below 0.9 m is generally called a mini antenna and used in office or at home. The method of manufacturing such antenna usually punches a whole piece of metal plate including but not limited to an aluminum plate into a disc body, and then the surface of the metal plate is coated by a light reflecting paint.

Many communication or television companies print their trademark pattern 12 onto the disc surface 11 as shown in FIG. 1B to achieve the commercial and advertising effects. However, the disc surface 11 is installed outdoors and exposed to wind, rain and sunlight all the time, and thus the trademark pattern 12 printed, adhered or coated on the disc surface 11 will be faded or peeled off easily, and the advertising effect will no longer exist, or the company's image may be ruined. This problem causes tremendous trouble to companies.

With reference to FIGS. 2A and 2B for another conventional disc antenna 20, this disc antenna comes with a bigger size and comprises a plurality of sheet metal nets 21 and a connecting edge 22 disposed on both sides of each metal net 21. The disc antennas of this sort are disclosed in U.S. Pat. Nos. 4,568,945 and 4,074,731. However, the hollow area of the metal net 21 is greater than the surface area of the meshed wires formed by intersected longitudinal and transversal wires. If the trademark pattern is painted onto the disc antenna, it will be difficult to display the trademark pattern 23 clearly because the meshed wires are very fine.

Therefore, it is a subject of the present invention to develop a disc antenna to overcome climatic changes and display the trademark pattern on the disc antenna.

### SUMMARY OF THE INVENTION

A primary object of the invention is to overcome the shortcomings of the prior art by providing a satellite disc antenna formed by punching holes on a metal plate to constitute a holed plate with densely distributed hollow holes, and keeping the disc surface of the expected trademark pattern free of holes, so that the integrally formed trademark pattern can be displayed clearly on the disc surface by the visual contrast effect, and the satellite disc antenna can be manufactured synchronously to minimize the influence of climate changes and overcome the peeling-off issue.

Another object of the present invention is to provide a satellite disc antenna, whose disc surface formed by punching holes on a metal plate provides an effect of reducing the wind resistance, so that an installed disc antenna will not be titled or blown away by strong winds easily, and the invention enhances the durability of the antenna and maintains the reliability of receiving signals.

In order to achieve the above-mentioned objects, the method in accordance with the invention includes the following steps:
(a) selecting a metal plate, and calculating a hole diameter and a hole distance of the hollow holes according to a predetermined formed area, and maintaining an area of forming the predetermined trademark pattern free of punched holes;
(b) selecting a punching mold, and installing an array punching pin according to the hole diameter and the hole distance of the desired punched holes of the metal plate, and then removing the punching pin that corresponds to the predetermined formed trademark on the metal plate;
(c) putting the metal plate into the punching mold for performing a hole punching operation for the metal plate;
(d) forming a holed plate with a plurality of densely distributed hollow holes, and enclosing the hollow holes around an external profile of the trademark pattern to constitute a visual contrast for displaying the trademark pattern clearly on a surface of the metal holed plate;
(e) cutting the holed plate to fit a blank of a predetermined shape and a predetermined area;
(f) putting the blank into a punching mold for pressing a disc surface of the blank according to a predetermined parabolic shape;
(g) performing a hemming operation at an external periphery of the disc surface to form a margin flange; and
(h) completing the satellite disc antenna having the metal holed plate with the integrally formed trademark pattern.

### BRIEF DESCRIPTION OF THE DRAWINGS

FIG. 1A is a perspective view of a conventional disc antenna;

FIG. 1B is a front view of a conventional disc antenna;

FIG. 2A is a perspective view of another conventional disc antenna;

FIG. 2B is a schematic view of a portion of a net body of another conventional disc antenna;

FIG. 3 is a flow chart of the invention;

FIG. 4A is a schematic view of a metal plate of the invention;

FIG. 4B is another schematic view of a metal plate of the invention;

FIG. 5A is a schematic view of a punching pin arrangement of a punching mold in accordance with the invention;

FIG. 5B is another schematic view of a punching pin arrangement of a punching mold in accordance with the invention;

FIG. 6 is a schematic view of a punch made by a punching mold in accordance with the invention;

FIG. 7 is a perspective view of a portion of a holed plate in accordance with the invention;

FIG. 8 is a front view of a holed plate in accordance with the present invention;

FIG. 9 is a front view of forming a blank in accordance with the invention;

FIG. 10 is a schematic view of a punching mold of the present invention;

FIG. 11 is a schematic view of forming a disc surface in accordance with the invention;

FIG. 12 is a schematic view of hemming an edge in accordance with the invention;

FIG. 13 shows a using status after a shaping is made in accordance with the invention;

FIG. 14 shows another using status after a shaping is made in accordance with the invention; and

FIG. 15 shows a further using status after a shaping is made in accordance with the invention.

### DETAILED DESCRIPTION OF THE PREFERRED EMBODIMENTS

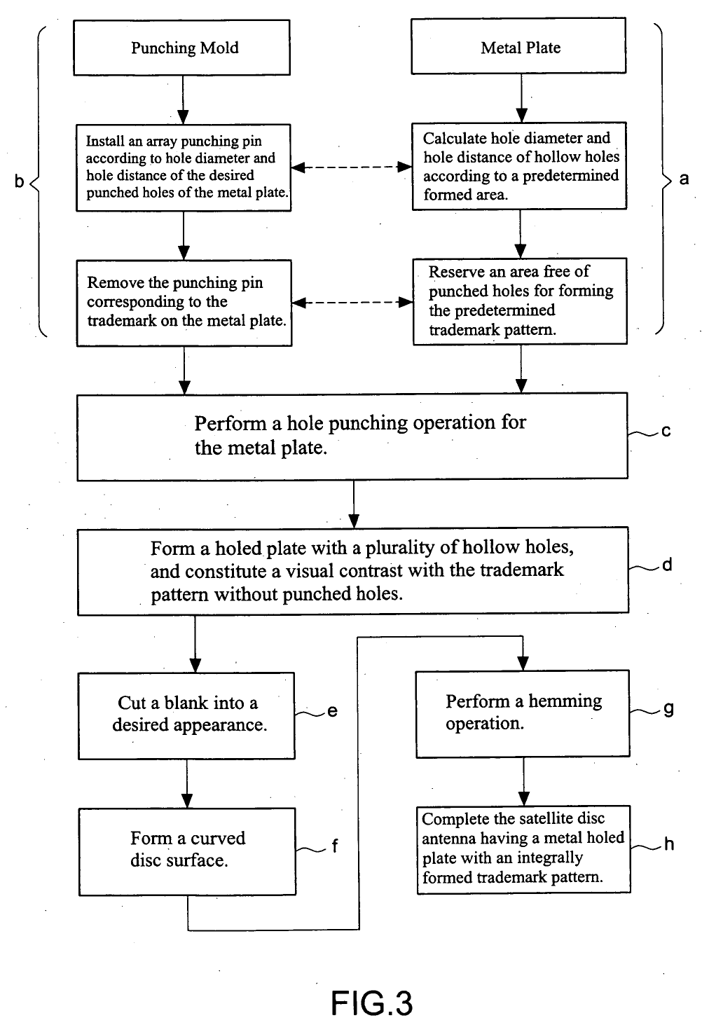

With reference to FIG. 3 for a flow chart of a manufacturing method of a satellite disc antenna in accordance with the present invention, the method comprises the following steps:

(a) Select a metal plate, and calculate a hole diameter and an hole distance according to a predetermined formed area. In other words, the hole diameter and the hole distance of the desired punched holes are calculated according to the predetermined area of the formed satellite disc antenna in advanced. For those skilled in the art, the hole diameter and the hole distance must comply with the area, receiving frequency and wavelength of the disc antenna to meet user requirements. In general, the hole distance HD can be calculated by HD<λ/20, and the wavelength λ can be obtained by Constant Velocity of electric wave in vacuum V÷Operating Frequency f, or λ=V/f. After λ is calculated, an appropriate hole diameter can be obtained. Since the magnitude of hole distance is not the subject of the present invention, the hole diameter is made according to the general conventional way which will not be described here.

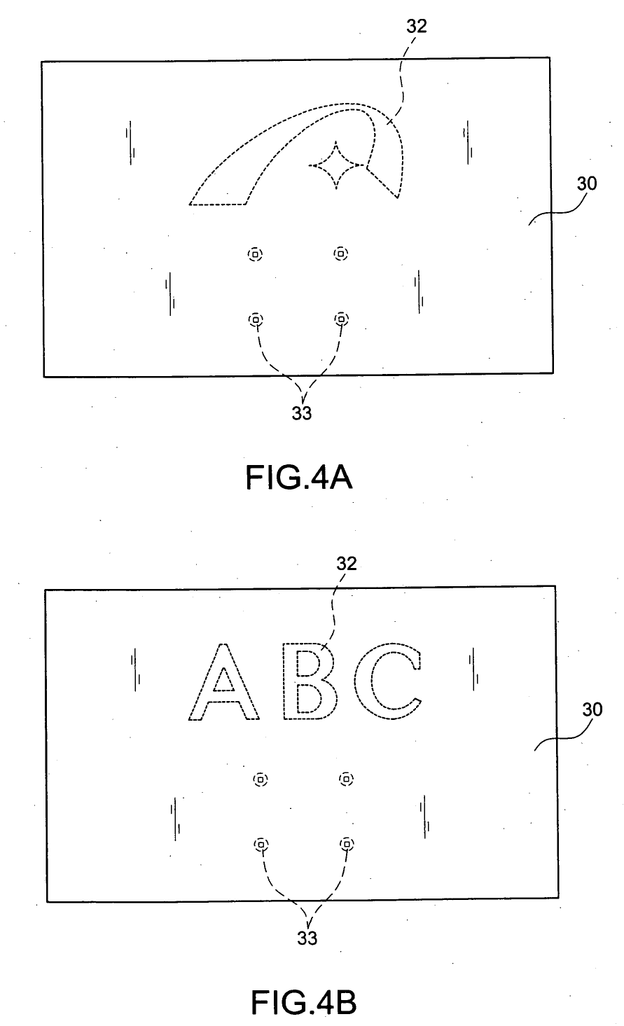

With reference to FIGS. 4A and 4B, the predetermined position of forming the trademark pattern 32 of the present invention is maintained free of punched holes when the hole diameter and the hole distance of the metal plate 30 are calculated. The trademark pattern 32 of the invention comprises a text, a figure or a combination of the text and the figure as shown in FIGS. 4A and 4B. The blocks enclosed by the dotted lines as shown in FIGS. 4A and 4B are reserved areas that are free of punched holes. Further, a plurality of fixing surfaces 33 with central locking holes are reserved at appropriate positions for installing and mounting the disc antenna in the future, and the fixing surfaces 33 are provided for securing screws onto a support stand (not shown in the figure).

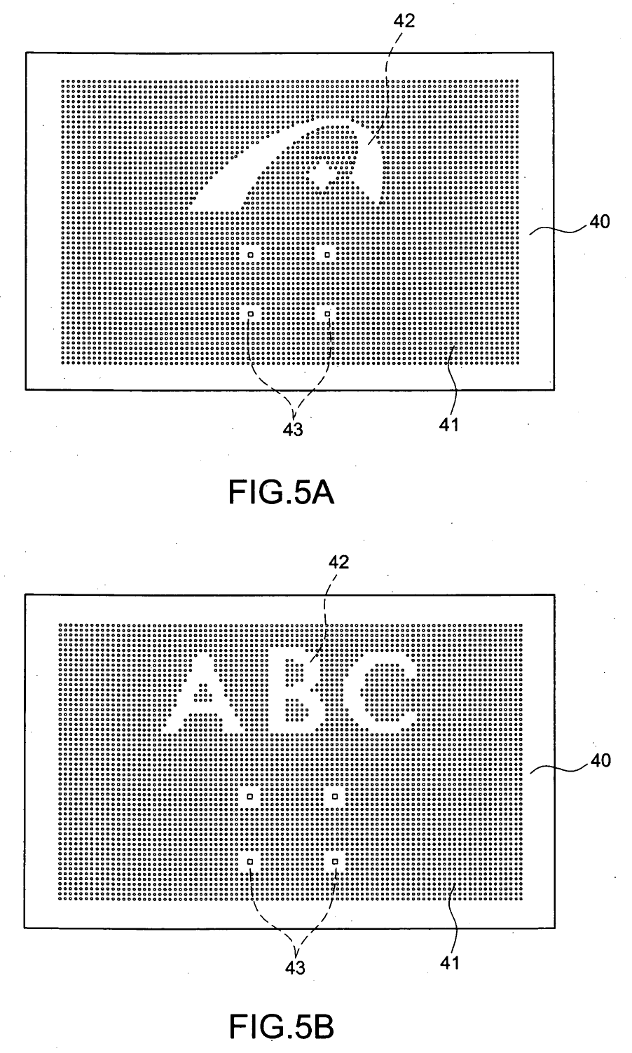

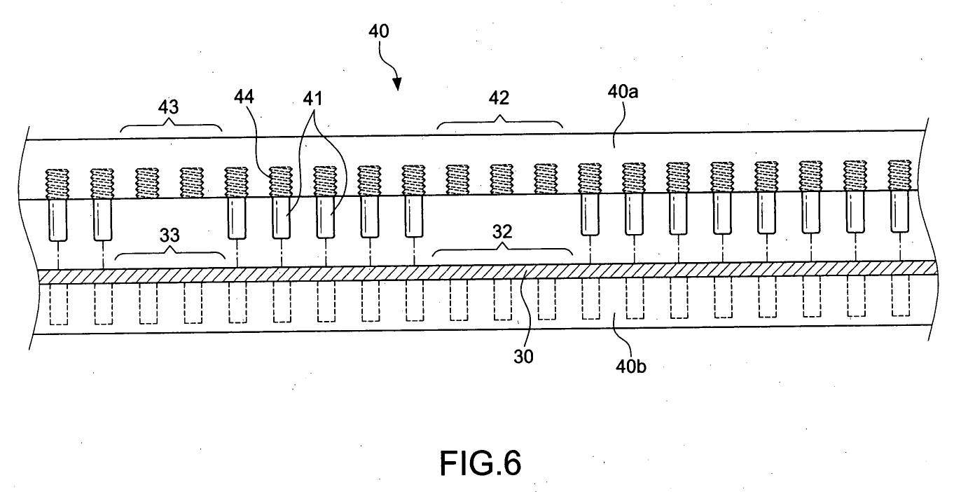

(b) Select a punching mold 40 as shown in FIGS. 5A and 5B, and install an array punching pin 41 according to a hole diameter and a hole distance of a desired punched hole of the metal plate 30 as shown in FIG. 6, and the punching pin 41 is installed into an installing hole 44 of an upper mold 40a. Remove the punching pin 41 corresponding to the predetermined formed trademark pattern 32 or the fixing surface 33 on the metal plate 30. In FIGS. 5A and 5B, blank areas 42, 43 of the punching mold 40 are areas for removing the punching pin 41, and these areas 42, 43 are also the desired positions of the trademark pattern 32 or the fixing surface 33 as shown in FIGS. 4A and 4B.

(c) Put the metal plate 30 into the punching mold 40 as shown in FIG. 6 for performing a hole punching operation. In other words, upper and lower molds 40a, 40b are engaged with each other, such that the punching pins 41 form punch holes with a predetermined hole diameter and a hole distance on the metal plate 30.

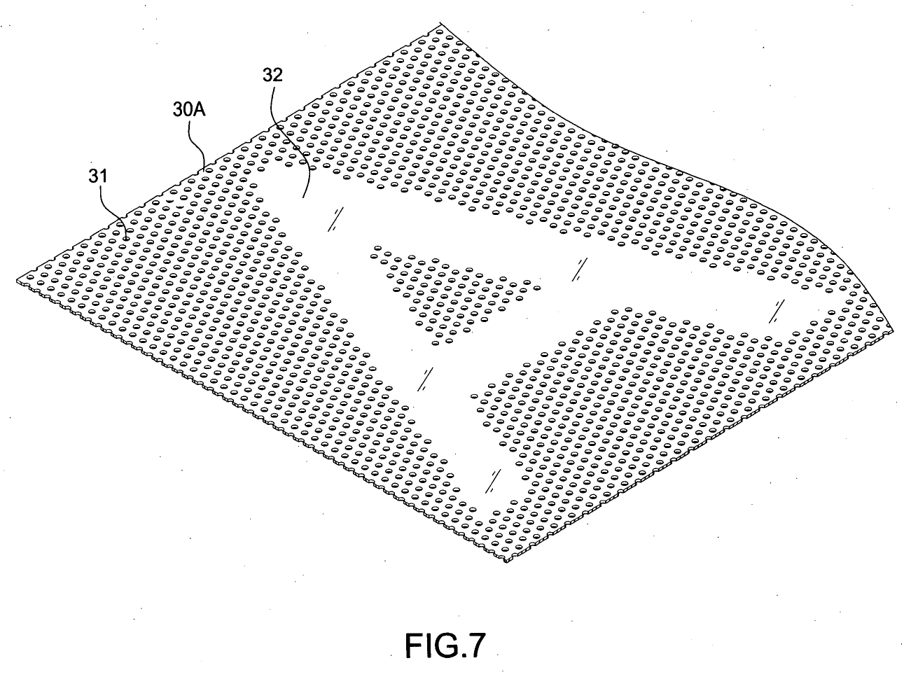

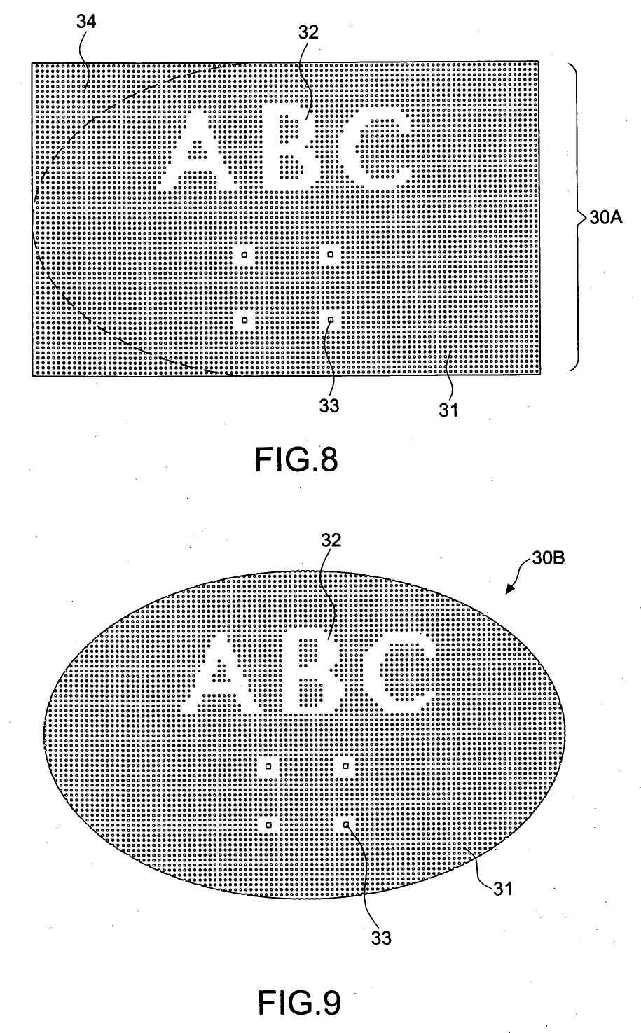

(d) Form a holed plate 30A with densely distributed hollow holes 31 as shown in FIG. 7, wherein the densely distributed hollow holes 31 are provided for enclosing an external profile of the trademark pattern 32. In other words, the surface of the trademark pattern 32 is a plane without any punched hole, and thus it is opaque. After the whole metal holed plate 30A is manufactured as shown in FIG. 8, many holes 31 are formed for displaying the text or the figure of the trademark pattern 32 onto the holed plate 30A by the visual contrast at the position of the trademark pattern 32 without any punched hole. This step is the preliminary manufacture, and following manufacturing steps give a more prominent trademark pattern 32.

(e) Cut the holed plate 30A to fit a blank 30B with a predetermined shape and a predetermined size as shown in FIG. 9. For example, an external remaining plate 34 is cut.

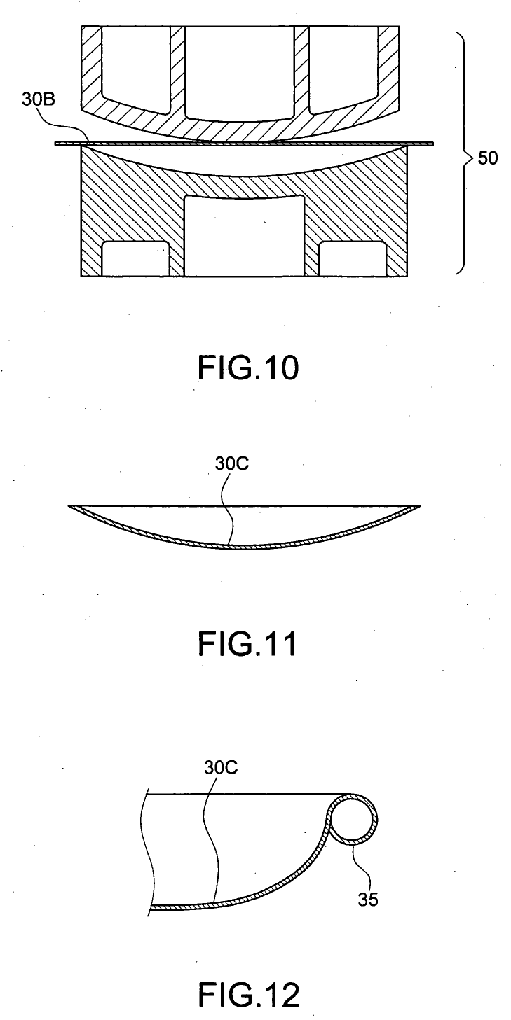

(f) Put the blank 30B into a punching mold 50 as shown in FIG. 10, such that the blank 30B presses a disc surface 30C as shown in FIG. 11 according to a predetermined parabolic shape.

(g) Perform a hemming operation for the external periphery of the disc surface 30C as shown in FIG. 12 to produce a margin flange 35 for preventing the external rough periphery of the blank from injuring people, and the margin flange 35 can enhance the strength of the whole disc body and prevent the disc body from being deformed.

(h) Complete the satellite disc antenna 30D having the metal holed plate with the integrally formed trademark pattern 32.

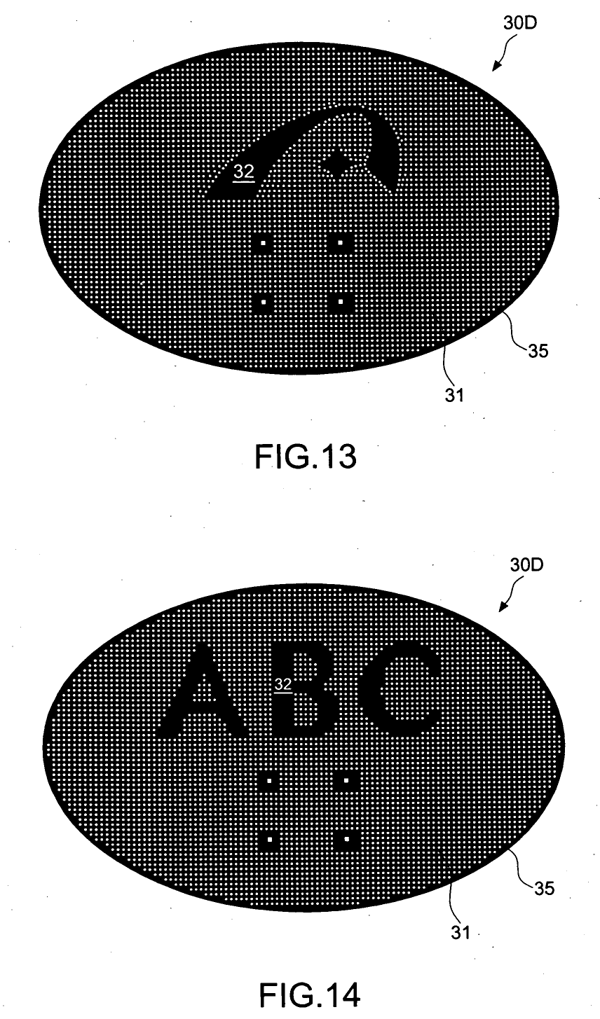

With the foregoing technical measures, the satellite disc antenna 30D of the invention can be manufactured by punching holes on the metal plate. Regardless of the color of the metal plate, densely distributed tiny hollow holes 31 are disposed on the surface of the metal plate, and thus the trademark pattern 32 without punched holes produces a visual contrast. After the disc antenna is punched and formed, a general chemical process such as an electroplating process is conducted as shown in FIGS. 13 and 14. If the satellite disc antenna 30D is plated with a dark or black color, then the trademark pattern 32 integrally formed with the satellite disc antenna 30D that is installed at the roof or an open area is prominent, since the light transmitting hollow holes 31 are densely distributed around the trademark pattern 32 and under the contrast of the light. The display effect is much better than the printed or coated trademark pattern of the prior art. More importantly, the trademark pattern of the invention does not have any peeled off issue at all.

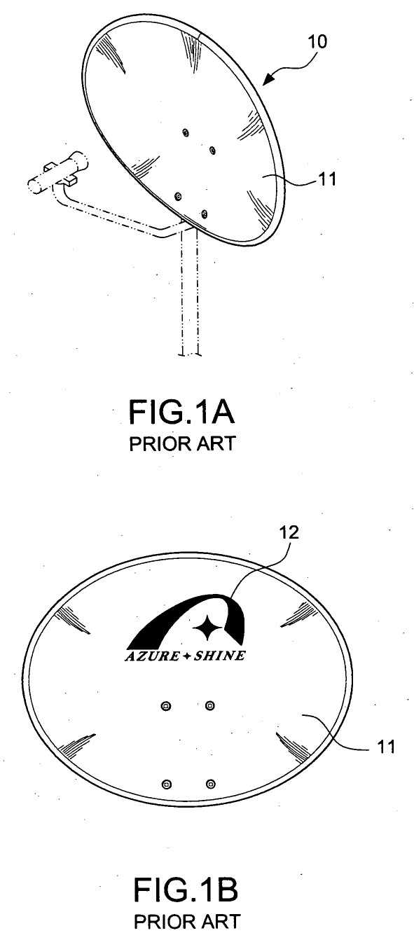

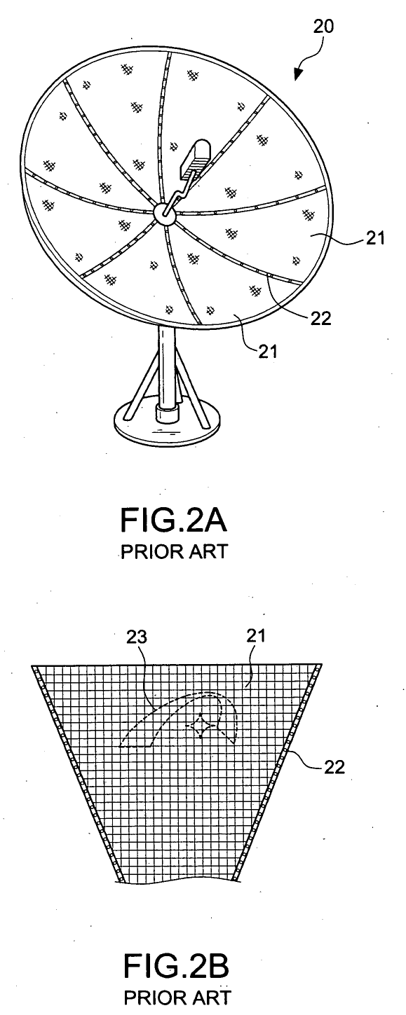

In the present invention, the hole diameter and the hole distance of the hollow holes 31 can be calculated, and the effect of receiving signals by the satellite disc antenna depends on an accurate curvature of the disc body. In other words, the collection of satellite signals will not be affected, as long as the hole diameter of the hollow holes 31 falls within the range of the predetermined size. Therefore, the metal plate with punched hollow holes 31 will not affect the effect of receiving signals, and the densely distributed hollow holes 31 can reduce wind resistance and bear a large wind loading. The invention is superior to the conventional disc antenna 10 made of a metal plate as shown in FIGS. 1A and B. Since the hollow holes 31 do not affect the overall mechanical strength of the disc surface but reduces the wind resistance and increases the wind loading capability, the meshed disc antenna 20 made of metal wires as shown in FIGS. 2A and 2B provides a better mechanical strength. As the disc antenna of the invention is not made of metal wires but made of a holed plate 30A formed by punching holes on the metal plate 30, the strength of the metal plate can be maintained, and the parabolic shape of the disc antenna can prevent the antenna from being deformed, and thus the invention can overcome the shortcomings of the conventional disc antenna that may be affected easily by external environments and deformed or damaged after being used for a while, thereby causing an inaccurate parabolic shape that is hardly capable of collecting weak electric waves.

The present invention not only integrally forms the trademark pattern 32, but also achieves the effects of displaying the trademark clearly through the hollow holes 31, reducing the wind resistance, and decreasing the weight of the disc antenna for easy transportation and installation without affecting the mechanical strength of the disc surface.

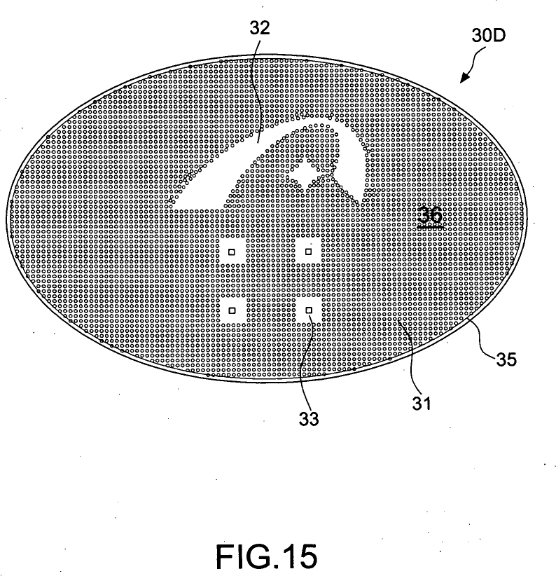

The black color used in FIGS. 13 and 14 cannot give a good effect of showing the numerals, and thus a general figure (FIG. 15) is used for illustrating the satellite disc antenna 30D in accordance with the present invention. The structure of the satellite disc antenna 30D comprises:

a disc surface 36, made of a metal plate, and having a plurality of densely distributed hollow holes 31 disposed thereon; and

a trademark pattern 32, integrally formed on the disc surface 36 and disposed at a surface without the hollow holes, and the trademark pattern 32 being enclosed by the densely distributed hollow holes 31 on the disc surface 36 to form an external profile of the trademark pattern 32 and constitute a contrast effect with the hollow holes 31 by the visual contrast as shown in FIG. 13, such that the trademark pattern 32 can be displayed clearly on the disc surface 36.

The disc surface 36 further includes a fixing surface 33 having a plurality of locking holes, and a margin flange 35 disposed around the external periphery of the disc surface 36.

With the foregoing assembly, the satellite disc antenna 30D of the invention can be made with a predetermined area and a predetermined shape (such as the dimensions of a mini antenna). Of course, the satellite disc antenna 30D can be made with a bigger size according to the specifications of mid-size and large-size antennas. Regardless of the size, the integrally formed trademark pattern is displayed by the hollow holes, and the wind resistance is reduced without changing the original functions.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A manufacturing method of a satellite disc antenna that displays an integrally formed trademark by a visual contrast of a plurality of hollow holes, and the method comprising the steps of:
(a) selecting a metal plate, and calculating a hole diameter and a hole distance of the hollow holes according to a predetermined formed area, and maintaining an area of forming the predetermined trademark pattern free of punched holes;
(b) selecting a punching mold, and installing an array punching pin according to the hole diameter and the hole distance of the desired punched holes of the metal plate, and then removing the punching pin that corresponds to the predetermined formed trademark on the metal plate;
(c) putting the metal plate into the punching mold for performing a hole punching operation for the metal plate;
(d) forming a holed plate with a plurality of densely distributed hollow holes, and enclosing the hollow holes around an external profile of the trademark pattern to constitute a visual contrast for displaying the trademark pattern clearly on a surface of the metal holed plate;
(e) cutting the holed plate to fit a blank of a predetermined shape and a predetermined area;
(f) putting the blank into a punching mold for pressing a disc surface of the blank according to a predetermined parabolic shape;
(g) performing a hemming operation at an external periphery of the disc surface to form a margin flange; and
(h) completing the satellite disc antenna having the metal holed plate with the integrally formed trademark pattern.

2. The manufacturing method of a satellite disc antenna that displays an integrally formed trademark by a visual contrast of a plurality of hollow holes as recited in claim 1, wherein the predetermined trademark formed on the metal-plate comprises a figure, a text, or a combination of the figure and the text.

3. The manufacturing method of a satellite disc antenna that displays an integrally formed trademark by a visual contrast of a plurality of hollow holes as recited in claim 1, wherein the step (a) further comprising a fixing surface with a plurality of reserved locking holes.

4. A satellite disc antenna structure, comprising:
a disc surface, made of a metal plate in a parabolic shape, and having a plurality of densely distributed punched hollow holes; and
a trademark pattern, integrally formed on the disc surface and at a position without the hollow holes, and enclosed by the densely distributed hollow holes on the disc surface to form an external profile of the trademark pattern and constitute a visual contrast with the hollow holes for displaying the trademark pattern clearly on the disc surface.

5. The satellite disc antenna structure as recited in claim 4, wherein the disc surface includes a fixing surface with a plurality of locking holes.

6. The satellite disc antenna structure as recited in claim 4, wherein the disc surface includes a margin flange with a hemmed edge and disposed at an external periphery of the disc surface.
